(19) United States
(12) Patent Application Publication
(10) Pub. No.: US 2005/0025430 A1
(43) Pub. Date: Feb. 3, 2005

(54) Apparatus and methods for passive alignment of optical elements

(76) Inventors: Venkata A. Bhagavatula, Big Flats, NY (US); Sean Garner, Elmira, NY (US); James S. Sutherland, Corning, NY (US)

Correspondence Address: CORNING INCORPORATED, SP-TI-3-1, CORNING, NY, 14831, US

(21) Appl. No.: 10/626,457

(22) Filed: Jul. 23, 2003

Related U.S. Application Data
(60) Provisional application No. 60/398,144, filed on Jul. 23, 2002.

(51) Int. Cl. G02B 6/26

(52) U.S. Cl. 385/52

(57) ABSTRACT

Apparatus and methods for passively aligning optical elements are disclosed. In certain embodiments, the apparatus and methods include optical elements aligned on bases which are passively aligned and secured on a substrate by alignment features adapted to secure and passively align the bases.

### CROSS REFERENCE TO RELATED APPLICATIONS

This application claims priority from U.S. Provisional Application 60/398,144, filed Jul. 23, 2002, entitled Apparatus and Methods for Passive Alignment of Optical Elements.

### FIELD OF THE INVENTION

This invention relates to passive alignment of optical elements.

### BACKGROUND OF THE INVENTION

In optical systems that include more than one optical element, alignment of the optical elements is critical to optimum system performance. Active alignment of the optical elements typically involves directing a light or photonic signal through one of the elements and positioning the elements until the optical specifications are met. As part of the active alignment process, when the elements are aligned, they are usually affixed in place by cement, solder or adhesive. A limitation of active alignment is that the technique is highly dependent on operator skill in determining alignment of the elements and affixing the elements in place. In addition, active alignment requires expensive equipment to generate and monitor optical signals.

An alternative to active alignment is passive alignment. Passive alignment involves aligning optical elements by only mechanical means and securing the elements in place. Typical mechanical alignment means include V-grooves, alignment blocks, jigs, and fixtures adapted to align an optical element to a substrate. As used herein, passive alignment is distinguished from active alignment in that passive alignment does not utilize the generation and monitoring of photonic signals to align the optical elements.

Although there are various existing passive alignment devices and methods currently available, it would be desirable to provide improved apparatus and methods for passively aligning optical elements. Furthermore, methods and apparatus are needed to align a wide variety of optical elements using simple and inexpensive processes and materials.

### SUMMARY

The invention relate to methods and apparatus for passively aligning optical elements. The various embodiments of the present invention provide relatively simple and inexpensive methods and apparatus for securing and passively aligning and securing optical elements to a substrate. The individual optical elements are aligned on bases adapted that are aligned and secured to a substrate. It is to be understood that both the foregoing general description and the following detailed description are exemplary and are intended to provide further explanation of the invention as claimed.

### BRIEF DESCRIPTION OF THE DRAWINGS

FIG. 1 is a partially exploded perspective view of an apparatus for passively aligning a plurality of optical elements according to one embodiment of the invention;

FIG. 2 is an assembled perspective view of the apparatus shown in FIG. 1;

FIG. 3 is a side view of a gripping element that can be used to passively align optical elements and substrates according to certain embodiments of the invention;

FIG. 4 is a side view of a gripping element with an optical element secured therein according to certain embodiments of the invention;

FIG. 5 is a fragmented side view of an optical element aligned on a base and the base passively aligned and secured on a substrate according to one embodiment of the invention;

FIG. 6a is a fragmented side view of an optical element aligned on a base and the base passively aligned and secured to a substrate according to one embodiment of the invention;

FIG. 6b is a fragmented side view of substrate for holding an optical element aligned on a base and the base passively aligned and secured to a substrate according to one embodiment of the invention

FIG. 7 is a partial exploded perspective view of an apparatus for passively aligning a plurality of optical elements according to another embodiment of the invention;

FIG. 8 is a cross-sectional view of a base and an optical element aligned on a base and passively aligned and secured to a substrate taken along line 8-8 of FIG. 7; and

FIG. 9 is a perspective view of an apparatus for passively aligning a plurality of optical elements according to another embodiment of the invention.

### DETAILED DESCRIPTION

Before describing several exemplary embodiments of the invention, it is to be understood that the invention is not limited to the details of construction or process steps set forth in the following description. The invention is capable of other embodiments and of being practiced or carried out in various ways.

In overview, certain embodiments of the present invention relate to apparatus for passive alignment of various optical elements, for example, elements including but not limited to optical fibers, lenses, filters, lensed fibers, vertical cavity surface emitting laser (VCSEL) arrays, optical isolators, and the like to substrates. Other embodiments relate to methods of securing and aligning such optical elements to bases to provide optical modules or modular optical elements. In certain embodiments, the optical elements are passively aligned on the bases. The apparatus and methods include a substrate that includes alignment features or receiving structures, for example, gripping elements, v-grooves, depressions, recessed regions, keys or trenches for securing and passively aligning optical modules or modular optical elements. The optical modules or modular optical elements are comprised of an optical element secured to a base that is adapted to be secured to the receiving structures or alignment features of the substrate so that the module is aligned on the substrate.

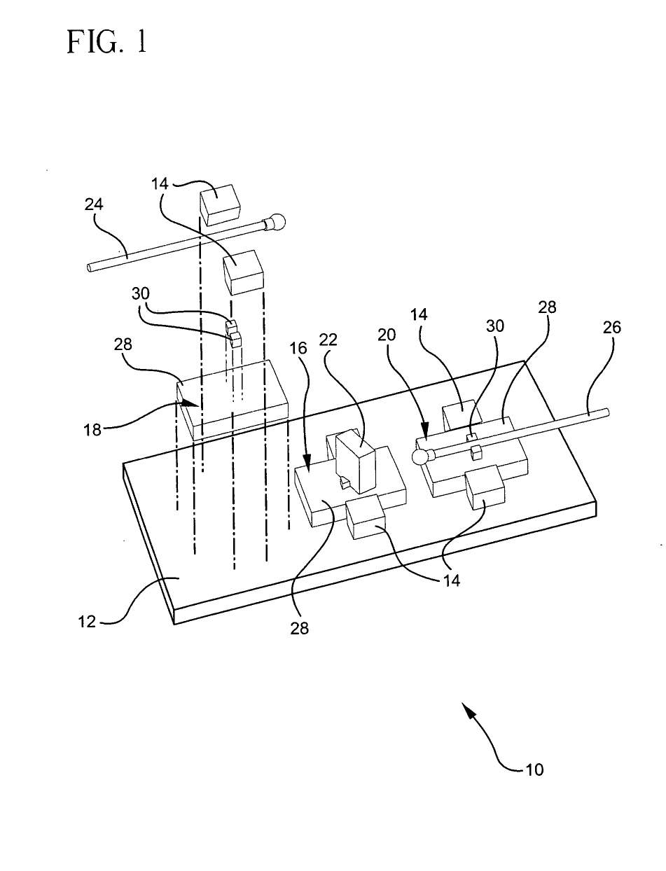

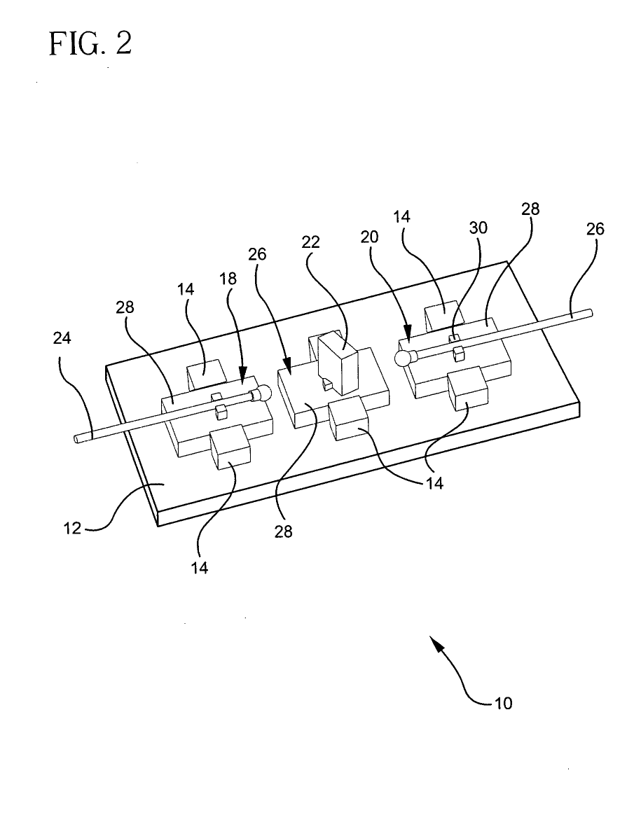

An exemplary apparatus for securing and passively aligning objects to substrates is shown in FIGS. 1 and 2. According to this embodiment, the apparatus 10 includes a substrate 12 having a plurality of standardized passive alignment features or receiving structures 14 in predetermined locations and configured to receive and passively align optical modules or modular optical elements 16, 18 and 20. In certain embodiments, each optsical module or modular optical element 16, 18 and 20 includes an optical element 22, 24, and 26 passively aligned and secured to a base 28 adapted to be received by the alignment features 14. In certain embodiments, the bases 28 have standardized features and or sizes so that they can be interchangeably secured to the substrate in a variety of locations. According to some embodiments, each base 28 is secured to the substrate 12 by cooperation with the passive alignment features or receiving structures 14. In addition, in certain embodiments, the bases are adapted to be secured to the substrate in various locations. In some embodiments, the optical elements are secured to the bases at predetermined spatial and angular positions. For example, optical elements such as thin film filter substrates could be fabricated that differ in orientation at various incremental angular positions to satisfy the alignment criteria of a variety of devices.

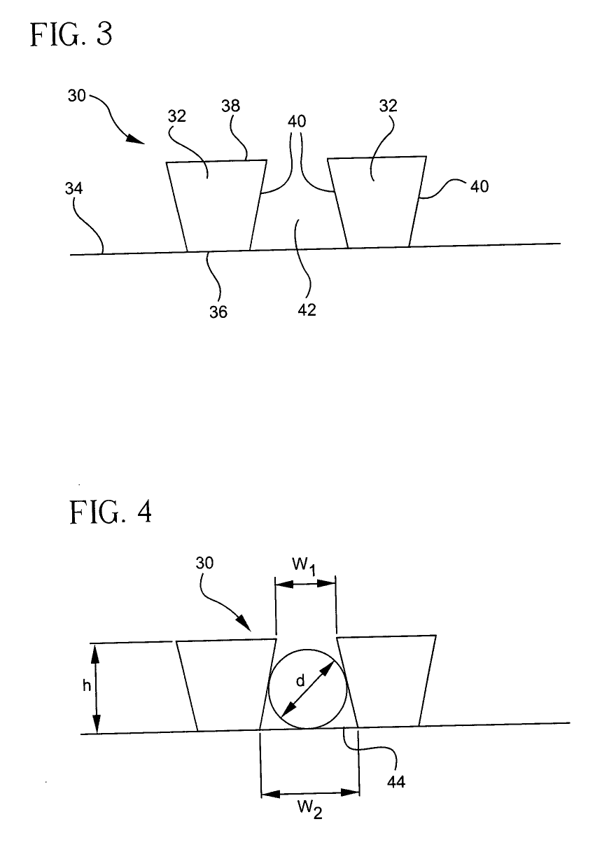

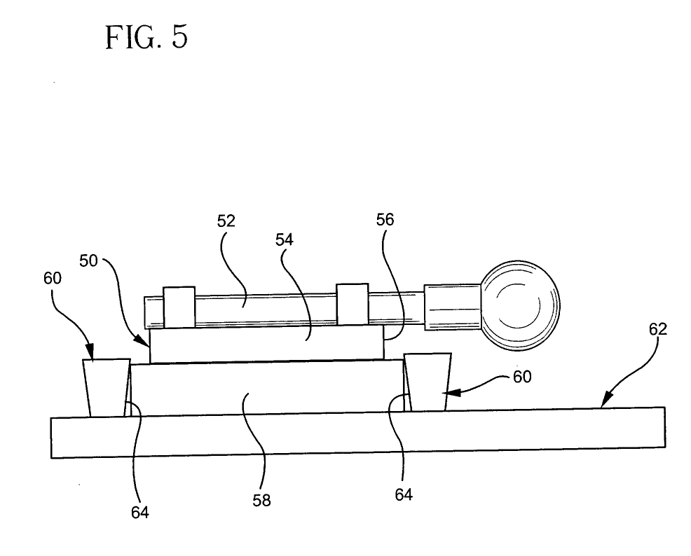

In the embodiment shown in FIGS. 1 and 2, the optical elements 22, 24 and 26 are passively aligned on the bases with a flexible gripping element 30. It will be understood that the invention is not limited to passive alignment of the optical elements to the bases that form the modules or modular optical elements. In certain embodiments, it may be desirable to actively align optical elements to bases to form the optical modules or modular optical elements. As will be discussed in more detail below, the optical elements can be passively aligned and secured on the bases by using other types of alignment features. Referring to FIGS. 3 and 4, FIG. 3 shows a more detailed view of a gripping element 30 that can be used as an alignment feature for passively aligning optical elements. It will be understood that although the details of the gripping element shown in FIG. 3 are particularly suitable for gripping elements adapted to secure and passively align cylindrical objects such as optical fibers, grin lenses, and the like, the gripping elements 30 can be sized and configured to secure and passively align a wide variety of other types of non-cylindrical optical elements, for example, including, but not limited to, prisms, lenses, VCSELS, etc. The gripping element 30 includes laterally spaced flexible strips 32 attached to the surface of a substrate 34. Each of the flexible strips has a base portion 36 attached to a surface of the substrate 34, a top surface 38 which is preferably substantially parallel with the surface of the substrate 34 and side walls 40 which provide a groove or channel 42 between the strips 32.

Referring now to FIG. 4, a portion of the substrate surface forms a floor 44 for the gripping element 30 so that the groove or channel has a width near the floor w₂ that is greater than the width w₁ at the top of the groove. Preferably, to adequately grip the surface of an optical element, the width w₁ at the top of the groove or channel is less than the diameter d of the optical element. If the optical element is not cylindrical, the width w₁ at the top of the groove or channel is less than the width of the optical element inserted into the groove or channel. The width w₂ at the bottom of the groove or channel is preferably greater than the diameter d of the cylindrical optical element or width of a non-cylindrical optical element (not shown). It will be understood that optical elements having a larger diameter will require a larger groove or channel to accept insertion of the optical element and to hold the optical in place vertically and horizontally along its axis. The sidewalls of each strip should be sufficiently flat so that each strip contacts the optical element in at least one point. U.S. Pat. No. 5,359,687, the entire contents of which are incorporated herein by reference, contains additional details on particular dimensions for telecommunications fibers.

The strips that make up the gripping elements can be formed using a variety of techniques such as well-known lithographic processes using photopolymerizable compositions and the like. For example, a photopolymerizable composition can be substantially uniformly deposited on onto a substrate surface. The photopolymerizable composition is then imagewise exposed to actinic radiation using a laser and a computer-controlled stage to expose precise areas of the composition with an ultraviolet laser beam, or a collimated UV lamp together with a photomask having a pattern of substantially transparent and substantially opaque areas. The nonimaged areas can then be removed with solvent, while leaving the imaged areas in the form of at least one gripping element on the substrate surface.

Alternatively, the flexible strips can be formed by using a soft, flexible embossing tool to pattern the polymerizable composition in the form of at least one gripping element on the substrate surface. Such soft tooling is commonly made with silicones. The composition is then cured and the tool is removed. The flexibility of the tool must be sufficient so that it can be removed from the cured polymer without damaging the grippers. The polymerizable composition may be cured by various means such as actinic radiation or heat, and should have the viscosity to conform to the raised features of the tool. After removing the tool from the cured composition, at least one gripping element will remain on the substrate, depending on the nature of the pattern. The pattern of the tool may include a plurality of gripping elements to provide a substrate for aligning an array of fiber and lenses. Suitable polymeric compositions for making the gripping elements are disclosed in commonly assigned U.S. Pat. No. 6,266,472.

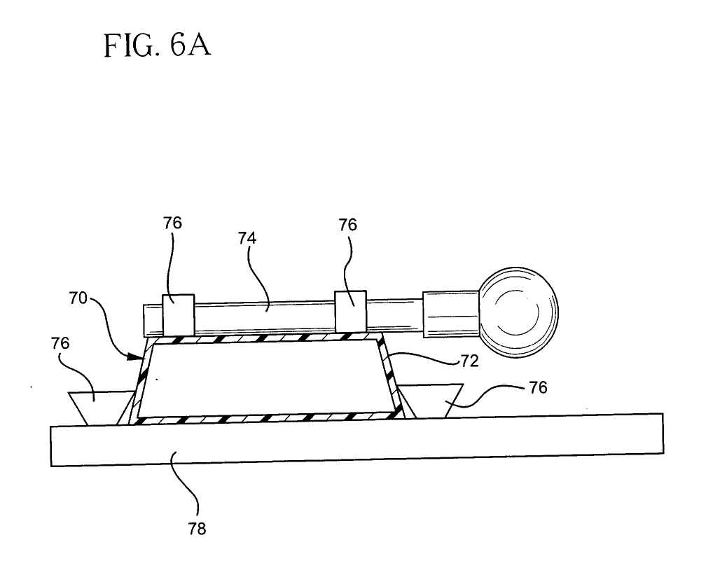

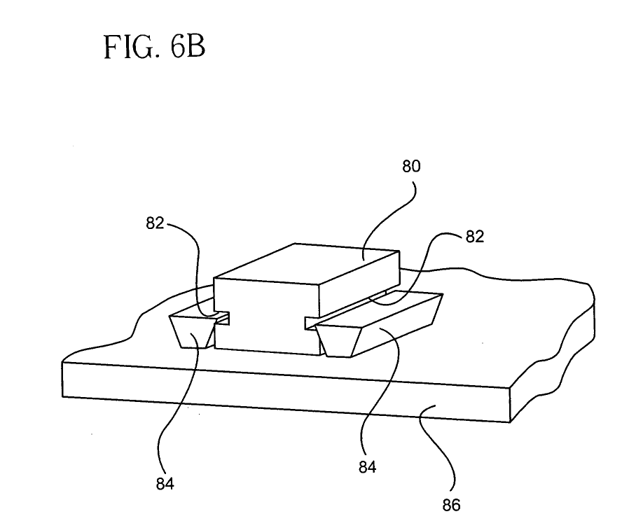

FIGS. 5, 6a and 6b show a few examples of types of alignment features or receiving structures for securing bases to the substrate. First referring to FIG. 5, module or modular optical element 50 comprises an optical element 52 secured to a base 54. In the embodiment shown in FIG. 5, the optical element 52 is a lensed optical fiber, but it will be understood that a variety of optical elements can be secured to the base. According to this embodiment, the base 54 has a stepped feature to provide an upper portion 56 and a lower portion 58 that engages with alignment feature or receiving structure 60 associated with substrate 62. In the embodiment shown in FIG. 5, the alignment feature or receiving structure includes a pair of flexible gripping elements including a pair of spaced sidewalls 64 that define a channel or groove adapted to accept the lower portion 58 of the base 54 and to secure the base to the substrate.

FIG. 6a shows a variant of a modular optical element or module 70 that includes a base 72 and an optical element 74 aligned and secured on the base 72. The optical element 74 is aligned on the base 72 by alignment features 76, which may be flexible gripping elements or any other suitable structure for passive alignment of the optical element. Substrate 78 includes alignment features or receiving structures 76 adapted to receive the base 72 and to secure and passively align the base 72 to the substrate 78. FIG. 6b shows another variant of a base 80 including alignment features 82 which are shown as grooves or channels in a side portion of the base 80 which are adapted to cooperate with alignment features 84 located on a substrate 86. FIGS. 5, 6a, and 6b demonstrate that the alignment elements 60, 76, and 84 do not necessarily need to be taller than the bases 54/58, 72, and 80 for proper securing.

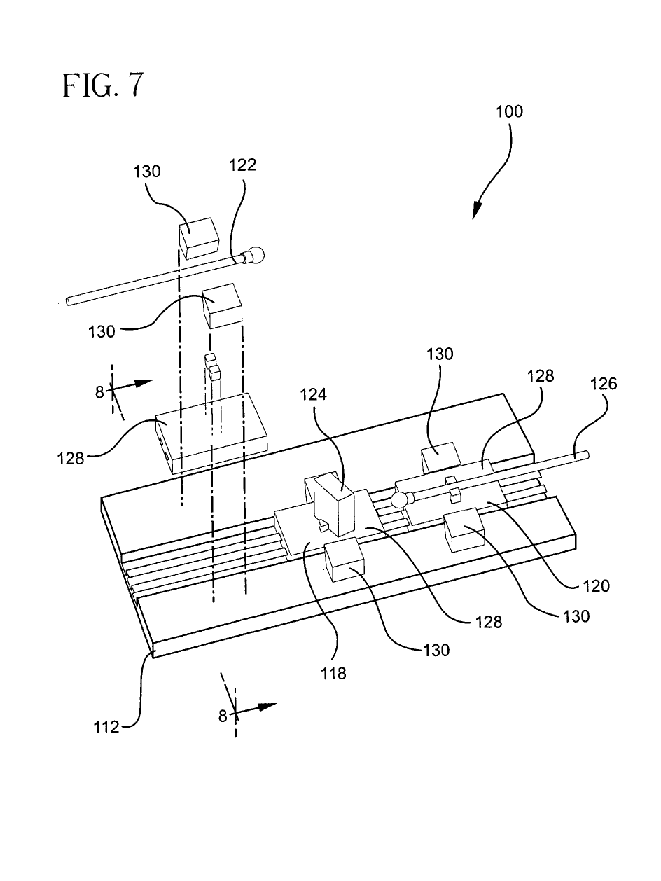

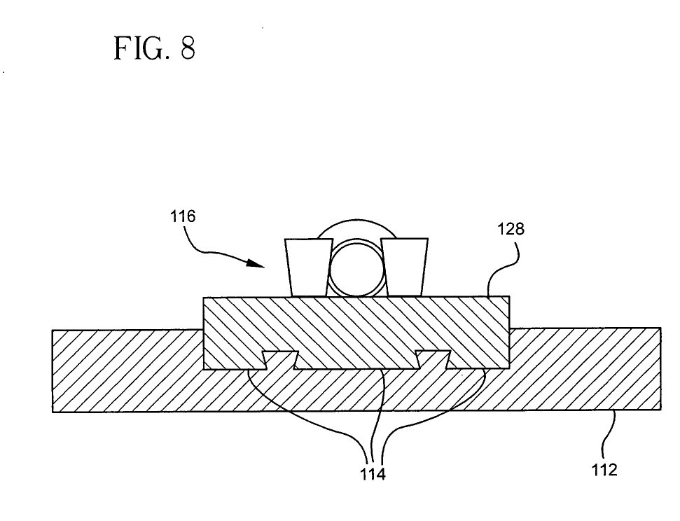

In an alternative embodiment shown in FIGS. 7 and 8, an apparatus 100 is shown having a substrate 112 that has alignment features or receiving structures 114 that include a recessed region, depression, groove or trench located in the surface of the substrate 112 adapted to receive the bases 128. Optical elements 122, 124 and 126 are aligned on the bases 128. The optical elements 122, 124 and 126 are aligned on bases 128 provides a plurality of optical modules or modular optical elements 116, 118 and 120. In certain embodiments, the bases 128 are sized, shaped and/or configured such that they are adapted to be received in the alignment features so that they passively align the optical modules 116, 118, and 120. In some embodiments, auxiliary alignment features 130 may be provided to aid in the alignment of the modules 116, 118, and 120. According to certain embodiments, the bases 128 and alignment features or receiving structures 114 are sized, shaped and/or configured so that the modules are interchangeable in a plurality of locations on the substrate.

In use, the apparatus of the present invention can be used to align and secure optical elements on bases that provide optical modules or modular optical elements that can be aligned and secured on a substrate. In some embodiments, the optical elements are passively aligned on a base to provide an optical module or modular optical element, and the optical module or modular optical element is passively aligned on a substrate. In other embodiments, the optical elements are actively aligned on the bases to provide the optical modules, and the modules are passively aligned on the substrate. In still other embodiments, the optical modules can be provided by passively aligning the optical elements to bases, and the optical modules are then actively aligned on the substrate. The modular design of the optical modules having bases that are in certain preferred embodiments interchangeable with a plurality of receiving structures or alignment features on a substrate will facilitate the passive alignment of a wide variety of optical elements on a substrate. According to one embodiment, a method of assembling an optical device including a plurality of passively aligned optical elements includes passively aligning and securing optical elements to bases and passively aligning and securing the bases to a substrate. Suitable receiving structures include, but are not limited to flexible gripping elements, v-grooves, depressions, grooves or trenches in the substrate, or combinations of these features. In preferred embodiments the optical elements are secured to the bases by flexible gripping elements of the type described above having a pair of spaced sidewalls defining a channel, the sidewalls adapted to hold the optical element in position on the bases. In certain preferred embodiments, the bases are sized and shaped to cooperate with the gripping elements to secure the base to the substrate such that they are interchangeable in each of the receiving structures or alignment features. By providing receiving structures or alignment features and bases that have predetermined and standardized sizes and features, interchangeability of modular optical elements mounted to bases on the substrate is facilitated.

According to some embodiments, the methods and articles of the present invention can be used to manufacture optical devices including a plurality of passively aligned optical elements on a substrate. Such optical elements can include, but are not limited to, prisms, filters, prisms including multiple thin film filters, switching elements such as a MEMS switches, electroholographic switches, optical isolators, lenses, mirrors, MEMs mirrors, VCSEL arrays, variable optical attenuation elements, tunable filters or LCD switches.

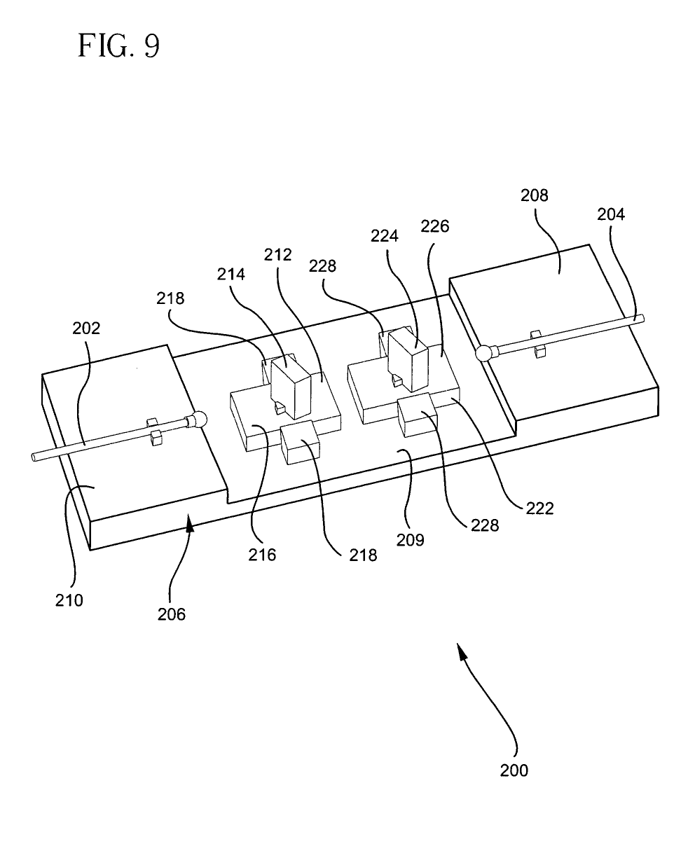

It will be understood that the methods and apparatus of the present invention can be used with other alignment methods and apparatus in combination. For example, the methods and apparatus of the present invention can be used to align and secure optical modules to a substrate having optical elements previously mounted to the surface of the substrate. The substrate containing the optical element can be modified to include alignment features that are adapted to receive an optical module comprising a base and an optical element such that the optical element on the base can be aligned with the optical element on the substrate. In addition, according to certain embodiments, it may be desirable to use a combination of alignment techniques to align optical elements on one substrate. For example, as shown in FIG. 9, apparatus 200 includes optical elements 202 and 204 mounted to a substrate 206 which includes raised portions 208 and 210. The optical elements 202 and 204 are mounted to raised portions 208 and 210. Optical modules 212 and 222 are aligned with optical elements 202 and 204. The optical modules 212 and 222 are aligned and secured on a lower portion 209 of the substrate 206. Optical module 212 includes an optical element 214 secured to a base 216, which is aligned on the substrate 206 by alignment features 218. Similarly, optical module 222 includes an optical element 224 secured to a base 226, which is aligned on the substrate 206 by alignment features 228. Certain of the optical modules may be passively aligned on the substrate, and certain other of the optical modules may be actively aligned on the substrate. In addition, in the manufacture of certain devices, certain optical elements may not be mounted in the same plane as the other optical elements. For example, base heights, alignment features, or substrate portions for given optical elements may cause different vertical alignments. It will be understood that various combinations of methods and apparatus and configurations of optical elements are within the scope of the invention.

Certain embodiments of the present invention provide passive alignment apparatus and methods that are inexpensive and require very few steps to achieve passive alignment of various optical elements. According to some embodiments of the present invention, optical element variability can be tolerated and compensated for by providing various pre-fabricated bases which can be passively aligned on a standardized substrate. In certain embodiments the bases used to secure the optical elements include alignment features that are specific to the individual optical element. After the elements have been passively aligned and secured to the bases, it may be desirable to use cement or adhesive to aid in securing the optical element in place. Likewise, cement or adhesive can be used to secure the bases to the substrates after proper alignment has been achieved. Alternatively, according to some embodiments, no adhesive needs to be used. In the design of optical devices, if the proper positional and angular alignment of the individual optical elements is known, the alignment features on the bases and on the substrate can be designed and properly positioned to achieve passive alignment.

According to certain embodiments of the present invention, a variety of materials and geometric shapes can be used as the substrate and bases, and a variety of manufacturing procedures may be used to fabricate them. The interchangeable part approach of certain embodiments of the present invention allows for low cost passive alignment of optical elements.

It will be apparent to those skilled in the art that various modifications and variations can be made to the present invention without departing from the spirit or scope of the invention. Thus, it is intended that the present invention cover modifications and variations of this invention provided they come within the scope of the appended claims and their equivalents.

1. An apparatus comprising:
a substrate including one or more passive alignment features in predetermined locations and configured to receive and passively align one or more optical modules; and
one or more optical modules, each module including an optical element aligned and secured to a base adapted to be received by the alignment features, each base secured to the substrate by cooperation with the passive alignment features.

2. The apparatus of claim 1, wherein the optical elements are secured to the bases at predetermined spatial and angular positions.

3. The apparatus of claim 1, wherein the optical elements are passively aligned on the bases with a flexible gripping element including a pair of spaced sidewalls defining a channel adapted to receive and secure the optical element to the substrate.

4. The apparatus of claim 1, wherein the bases are adapted to be secured to the substrate in various locations.

5. The apparatus of claim 1, wherein the passive alignment features include a flexible gripping element having a pair of spaced sidewalls defining a channel adapted to receive and secure the bases to the substrate.

6. The apparatus of claim 5, wherein sidewalls include upper portions and lower portions, and the spacing between the upper portions is less than the spacing between the lower portions.

7. The apparatus of claim 1, wherein the alignment features include a recessed region located in the surface of the substrate adapted to receive the bases.

8. The apparatus of claim 1, wherein the optical elements are selected from the group consisting of optical fiber, lensed fiber, prisms, filters, prisms including multiple thin film filters, switching elements such as a MEMS switches, lenses, graded index lenses, gratings, mirrors, MEMs mirrors, electroholographic switches, VCSEL arrays, variable optical attenuation elements, tunable filters and LCD switches.

9. The apparatus of claim 1, wherein the passive alignment features are standardized and the bases are standardized.

10. The apparatus of claim 1, wherein each of the bases can be secured to each of the alignment features in a plurality of standardized alignment features on the substrate.

11. An apparatus comprising:
a substrate including one or more alignment features in predetermined locations and configured to receive and align optical modules; and
one or more optical modules, each module including an optical element passively aligned and secured to a base adapted to be received by the alignment features, each base secured to the substrate by cooperation with the passive alignment features.

12. The apparatus of claim 11, wherein the alignment features are in predetermined locations on the substrate.

13. The apparatus of claim 11, wherein the alignment features are actively aligned on the substrate.

14. The apparatus of claim 13, wherein the alignment features include a flexible gripping element having a pair of spaced sidewalls defining a channel adapted to receive and secure the bases to the substrate.

15. An apparatus comprising:
a substrate having one or more receiving structures and one or more modular optical elements, each modular optical element including an optical element aligned on a base, each base adapted to be secured to the receiving structures such that the modular optical element is passively aligned on the substrate.

16. The apparatus of claim 15, wherein the receiving structures include a trench or groove adapted to receive the bases.

17. The apparatus of claim 15, wherein the receiving structure includes a flexible gripping element having a pair of sidewalls defining a channel.

18. The apparatus of claim 15, wherein the bases include standardized sizes and features adapted to cooperate with the receiving structures to secure the bases to the substrate.

19. The apparatus of claim 18, wherein each of the modular optical elements are interchangeable in each of the receiving structures.

20. A method of passively aligning optical elements comprising: aligning and securing one or more optical elements to bases; and
securing and passively aligning one or more of the bases to a substrate.

21. The method of claim 20, wherein the bases are passively aligned and secured on the substrate by a receiving structure.

22. The method of claim 20, wherein the optical elements are secured to the bases by flexible gripping elements having a pair of spaced sidewalls defining a channel, the sidewalls adapted to hold the optical element in position on the base.

23. The method of claim 21, wherein the receiving structure includes a flexible gripping element having a pair of spaced sidewalls defining a channel, the sidewalls adapted to hold the base in position on the substrate.

24. The method of claim 23, wherein the bases are sized and shaped to cooperate with the gripping element to secure the base to the substrate.

25. The method of claim 23 wherein the bases are sized and shaped such that they are interchangeable in each of the receiving structures.

27. The method of claim 21, wherein the receiving structure includes a depression in the substrate adapted to hold the base in position on the substrate.

28. The method of claim 21, wherein the receiving structures and bases have predetermined and standardized sizes and features.
